(19) United States
(12) Patent Application Publication
(10) Pub. No.: US 2025/0363420 A1
(43) Pub. Date: Nov. 27, 2025

(54) LOGISTICS MANAGEMENT SYSTEM PROVIDING ACCESS TO ASSET-SPECIFIC LARGE-LANGUAGE-MODEL AGENTS USING OPTICAL CODES

(71) Applicant: CargoSense, Inc., Reston, VA (US)

(72) Inventor: Richard Allen Christopher KILMER, Centreville, VA (US)

(73) Assignee: CargoSense, Inc., Reston, VA (US)

(21) Appl. No.: 19/215,770

(22) Filed: May 22, 2025

Related U.S. Application Data
(60) Provisional application No. 63/651,733, filed on May 24, 2024.

(51) Int. Cl. G06N 20/00; G06K 7/14

(52) U.S. Cl. CPC G06N 20/00; G06K 7/1413; G06K 7/1417

(57) ABSTRACT

A method for automatically configuring a machine learning model and providing access to the configured machine learning model is performed by a system comprising one or more processors. The method includes: receiving a transmission from a mobile device that includes decoded information based on an optical code associated with an asset, the decoded information including a lookup portion; retrieving custom response instructions associated with the asset from a storage location determined based on the lookup portion of the decoded information; transmitting the custom response instructions to a machine learning model; and transmitting instructions to the mobile device to display an interface at a display of the mobile device, the interface configured to enable a user of the mobile device to interact with the machine learning model subject to the custom response instructions.

### CROSS-REFERENCE TO RELATED APPLICATIONS

This application claims the benefit of U.S. Provisional Application No. 63/651,733, filed May 24, 2024, the entire contents of which are incorporated herein by reference.

### FIELD

This disclosure relates generally to natural language processing and more specifically to large language models.

### BACKGROUND

In logistics management systems, users may desire to quickly and easily retrieve information about a vast number of different assets, such as shipping containers, pallets, trailers, crates, boxes, storage rooms, commercial refrigerators, warehouses, production facilities, factories, delivery vehicles, and the like. Information about different assets within any given logistics management environment may be stored in various different data stores, e.g. databases, and may be accessed via various user interfaces that allow the users to read from and write to said data stores.

### SUMMARY

As explained above, information about different assets within any given logistics management environment may be stored in various different storage locations, such as data stores, and may be accessed via various user interfaces that allow the users to read from and write to said data stores. However, accessing, reading, and writing information via a large number of different platform-specific user interfaces may present a steep learning curve, may be difficult and cumbersome for users, and may limit the ability of the system to flexibly integrate with other automated system components. Accordingly, there is a need for improved systems and methods for accessing, reading from, and writing to databases and other data stores containing information about various assets in logistics management systems.

Disclosed herein are systems and methods that leverage optical codes, large language model (LLM) systems, and a customized data store of LLM custom response instructions to provide easily-accessible “agents” that imitate an asset monitored by a logistics management system. For example, for a given pallet monitored by a logistics management system, data with information regarding the pallet (e.g., what it is loaded with, its current location, its location history, etc.) may be stored in one or more data stores. While a conventional asset management system might require the use of one or more platform-specific user interfaces to access that information in the one or more data stores, the systems disclosed herein allow for simplified interaction with the pallet-including interrogation of the information stored in the one or more data stores-using a natural language understanding (NLU) interface such as an LLM. By providing an LLM configured to imitate the pallet itself, the system may provide the user intuitive information such as, “I am a pallet loaded with a shipment of Product Y from Company X.” The user can then ask additional questions of the pallet, via the NLU/LLM platform using natural language, for example, and the user may optionally provide new information to the system about the pallet that may be written to the one or more back-end data stores.

However, using LLMs to imitate assets monitored by a logistics management system may involve situations in which an LLM system is required to selectively imitate any one of thousands, hundreds of thousands, or millions of different assets or more. Due to token limits and other technical limitations of LLMs, it may be computationally and algorithmically infeasible for a single pre-trained LLM to selectively imitate extremely large numbers of different assets. Furthermore, it may be computationally expensive, cumbersome, and slow to manually train an LLM to selectively imitate extremely large numbers of different assets. Accordingly, there is a need for improved systems and methods for configuring LLMs to selectively imitate extremely large numbers of different assets (e.g., millions, tens of millions, hundreds of millions, or billions of different assets).

Disclosed herein are systems and methods that leverage prompt engineering in the form of custom response instructions in order to selectively configure a pre-trained LLM to selectively imitate extremely large numbers of different assets. The systems and methods disclosed herein may address one or more of the above-identified needs. Custom response instructions provide a way to effectively configure and specifically prompt pre-trained LLMs for specific use cases and applications. Custom response instructions may be provided to the LLM as text, processed by the LLM using its language-processing capabilities, and thereafter applied by the LLM when generating future responses to future prompts. In an example of a simple use case, an LLM deployed for educational purposes in a high school might be prompted with a custom instruction that “All responses should be explained at a level of complexity suitable for teenagers.” The LLM may process that custom instruction such that, thereafter, responses may be generated by the LLM subject to the custom instruction and responses may be generated that are appropriate for the high school level. In the context of a logistics management system, as described herein, custom response instructions may be quickly and effectively used to prompt a pre-trained LLM with custom response instructions that instruct the LLM to imitate a specific asset and/or that provide the LLM with specific information (e.g., data from a logistics data store) regarding the asset to be imitated. In a simple case, the custom response instruction might be: “You are a pallet carrying a shipment of [product P] from [company C], and you departed [location L] at [time T]. Respond to all subsequent queries and prompts during this session accordingly.” By leveraging prompt engineering with custom response instructions that are specific to a particular asset and to a particular asset's current location and status, a general-purpose pre-trained LLM may thus be quickly configured to imitate a vast number of different assets. By storing custom response instructions in a data store and retrieving them therefrom, an LLM may be quickly and flexibly configured to selectively imitate millions (or more) different assets as needed.

Thus, using custom response instructions for LLMs in an asset management system may provide a powerful tool for configuring LLMs to imitate large numbers of different assets, increasing their usability for human users and their flexibility and interactive functionality for integration with other technical systems. However, the task of obtaining the correct custom response instructions for a given asset in a system managing very large numbers of assets may itself be cumbersome, computationally expensive, and/or require manual navigation of complex data stores or user interfaces. Accordingly, there is a need for improved systems and methods for quicky, efficiently, and accurately looking up custom response instructions for a particular asset being managed by an asset management system, and for automatically providing said custom response instructions to an LLM to be used to prompt the LLM to imitate the asset.

Disclosed herein are systems and methods that leverage optical codes to facilitate quick, efficient, and accurate lookup of custom response instructions for prompting an LLM to imitate a particular asset being managed by an asset management system. The systems and methods disclosed herein may address one or more of the above-identified needs. In some embodiments, a system may include a plurality of unique optical codes (e.g., QR codes, or the like) that are distributed and physically attached (or provided nearby) to unique associated assets monitored by a logistics management system. In the case of a pallet, for example, a QR code may be mounted to the pallet. The QR code may encode a URL and/or other unique information that is usable by the logistics management system to look up custom response instructions associated specifically with the asset to which the QR code is attached. In some embodiments, scanning the QR code attached to the pallet using a user's mobile device may cause the mobile device to access a URL and instruct the logistics management system to automatically look up custom response instructions associated with the pallet, to automatically provide said custom response instructions to an LLM, and to automatically cause a graphical user interface to be provided to the user's device allowing the user to interact with the LLM (the LLM having already been configured to imitate the asset via the retrieved custom response instructions). Because the custom response instructions are tailored to a particular asset and can be sent to an LLM after a user merely scans a QR code, the methods described herein provide a faster, more specific, more reliable, more scalable way to prompt an LLM, and also allow for simpler, more flexible, computationally more efficient integration with other automated systems.

In some embodiments, a method for automatically configuring a machine learning model and providing access to the configured machine learning model is provided. The method can be performed by a system comprising one or more processors. In some embodiments, the method comprises: receiving a transmission from a mobile device comprising decoded information based on an optical code associated with an asset, wherein the decoded information comprises a lookup portion; retrieving custom response instructions associated with the asset from a storage location determined based on the lookup portion of the decoded information; transmitting the custom response instructions to a machine learning model; and transmitting instructions to the mobile device to display an interface at a display of the mobile device, the interface configured to enable a user of the mobile device to interact with the machine learning model subject to the custom response instructions.

In some embodiments, the storage location is a data store associated with the asset.

In some embodiments, the custom response instructions instruct the machine learning model to generate a response based on data in the storage location associated with the asset.

In some embodiments, the custom response instructions prompt the machine learning model to imitate the asset.

In some embodiments, the method further comprises: prior to transmitting instructions to the mobile device to display an interface at a display of the mobile device, establishing, based on an authentication portion of the decoded information, a connection between the mobile device and a machine learning model.

In some embodiments, the asset is any of a shipping facility, a location within a shipping facility, a system of a shipping facility, shipping facility equipment, or a shipped item.

In some embodiments, the method further comprises: receiving, by the machine learning model, a prompt from the mobile device based on a user input received through the interface; generating, by the machine learning model, an output based on the prompt; and transmitting instructions to the mobile device to display the output at the interface of the mobile device.

In some embodiments, the user input comprises a natural language input.

In some embodiments, the method further comprises: transmitting a write request for information included in the user input to the storage location associated with the asset.

In some embodiments, the method further comprises: transmitting a read request comprising a request for information to the storage location associated with the asset.

In some embodiments, the method further comprises: prior to generating the output based on the prompt, retrieving data from the storage location based on the read request, wherein the output is based on the data retrieved from the storage location.

In some embodiments, the output comprises the data retrieved from the storage location.

In some embodiments, prior to receiving a transmission from a mobile device comprising decoded information based on an optical code associated with an asset, the method further comprises: at the mobile device, detecting the optical code by an optical sensor of the mobile device; decoding a URL encoded in the optical code; and transmitting the URL to the system.

In some embodiments, the optical code is located physically on the asset.

In some embodiments, the optical code is not located physically on the asset.

In some embodiments, the decoded information comprises a URL associated with the machine learning model.

In some embodiments, the decoded information comprises a natural language prompt for prompting the machine learning model to imitate the asset.

In some embodiments, a system for automatically configuring a machine learning model and providing access to the configured machine learning model. In some embodiments, the system comprises one or more processors; and memory storing computer program code executable by the one or more processors to cause the system to: receive a transmission from a mobile device comprising decoded information based on an optical code associated with an asset, wherein the decoded information comprises a lookup portion; retrieve custom response instructions associated with the asset from a storage location determined based on the lookup portion of the decoded information; transmit the custom response instructions to a machine learning model; and transmit instructions to the mobile device to display an interface at a display of the mobile device, the interface configured to enable a user of the mobile device to interact with the machine learning model subject to the custom response instructions.

In some embodiments, a non-transitory computer readable storage medium storing one or more programs is provided. In some embodiments, the one or more programs comprise instructions, which, when executed by a system comprising one or more processors, cause the system to: receive a transmission from a mobile device comprising decoded information based on an optical code associated with an asset, wherein the decoded information comprises a lookup portion; retrieve custom response instructions associated with the asset from a storage location determined based on the lookup portion of the decoded information; transmit the custom response instructions to a machine learning model; and transmit instructions to the mobile device to display an interface at a display of the mobile device, the interface configured to enable a user of the mobile device to interact with the machine learning model subject to the custom response instructions.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary system for causing display of an interface at a display of an electronic device, in accordance with some embodiments herein.

FIG. 2 illustrates an exemplary method for prompting an LLM with custom response instructions and providing access to said prompted LLM in response to scanning an optical code, in accordance with some embodiments herein.

FIG. 3 illustrates another exemplary method for prompting an LLM with custom response instructions and providing access to said prompted LLM in response to scanning an optical code, in accordance with some embodiments herein.

FIG. 4 illustrates another exemplary method for prompting an LLM with custom response instructions and providing access to said prompted LLM in response to scanning an optical code, in accordance with some embodiments herein.

FIG. 5 illustrates another exemplary method for prompting an LLM with custom response instructions and providing access to said prompted LLM in response to scanning an optical code, in accordance with some embodiments herein.

FIG. 6 illustrates another exemplary method for prompting an LLM with custom response instructions and providing access to said prompted LLM in response to scanning an optical code, in accordance with some embodiments herein.

FIG. 7 illustrates a user interface on a display of an electronic device, in accordance with some embodiments herein.

FIG. 8 illustrates a computer, in accordance with some embodiments herein.

FIG. 9 illustrates an audible input into, and output out of, a user interface on a display of an electronic device, in accordance with some embodiments herein.

FIG. 10 illustrates a visual input into a user interface on a display of an electronic device, in accordance with some embodiments herein.

### DETAILED DESCRIPTION

Described herein are systems and methods for automatically configuring a machine learning model and providing access to the configured machine learning model. The systems and methods described herein can leverage optical codes, large language model (LLM) systems, and a customized data store of LLM custom response instructions to provide easily-accessible “agents” that imitate an asset monitored by a logistics management system. The data store of custom response instructions can allow for a pre-trained LLM to be selectively prompted to imitate extremely large numbers of different assets so as to provide a user with a user-friendly, efficient, and fast way of getting information on many different assets.

In some embodiments, a method for automatically configuring a machine learning model and providing access to the configured machine learning model includes receiving a transmission from a mobile device comprising decoded information based on an optical code (e.g., a QR code) associated with an asset. The decoded information can include a lookup portion that can specify a location of custom response instructions stored in a storage location, e.g., in a data store. These custom response instructions can be retrieved from the storage location and transmitted to a machine learning model so that the machine learning model can selectively imitate the asset in the manner prompted by the custom response instructions. A mobile device (e.g., a cell phone) may then receive instructions to display a user interface configured to enable a user of the mobile device to interact with the machine learning model. The machine learning model may respond to the user's input into the user interface in a manner specified by the custom response instructions. In some embodiments, a system is provided, the system comprising one or more processors and memory storing instructions for the system to carry out the methods described herein.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

### Exemplary System

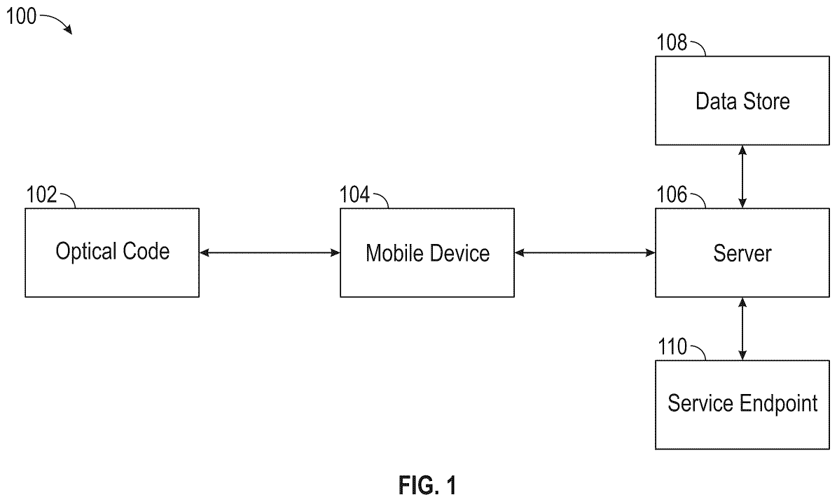

FIG. 1 illustrates an exemplary system that can be used for causing display of an interface at a display of a mobile device configured to enable a user to interact with a pre-trained machine learning model, where the machine learning model is configured to generate responses associated with an asset. As shown in FIG. 1, optical code 102 can be received by a mobile device 104. Optical code 102 may be a QR code, bar code, or any other machine-readable image or symbol. Mobile device 104 may be a mobile phone, tablet, barcode scanner, a QR scanner, or any other device with an optical sensor capable of scanning and decoding the optical code. For example, mobile device 104 could be a smartphone with a camera. There may be information encoded within optical code 102 that can be decoded by the mobile device. Mobile device 104 can then transmit the decoded information to a server 106. As will be explained in more detail, based on the decoded information received from mobile device 104, server 106 may access a data store 108 and/or a service endpoint 110. Server 106 may be any server capable of meeting the demands of a machine learning model such as a large language model (LLM). Service endpoint 110 may include an LLM, a retrieval model, other types of language models, and/or multimodal models. Data store 108 may include any storage location, database, etc. capable of meeting the demands of an LLM, a multimodal machine learning model, or the like. As will be explained in more detail, data store 108 may contain a resource, such as custom response instructions, data collected by a device or sensor, etc., that may be used to prompt the LLM.

### Exemplary Method

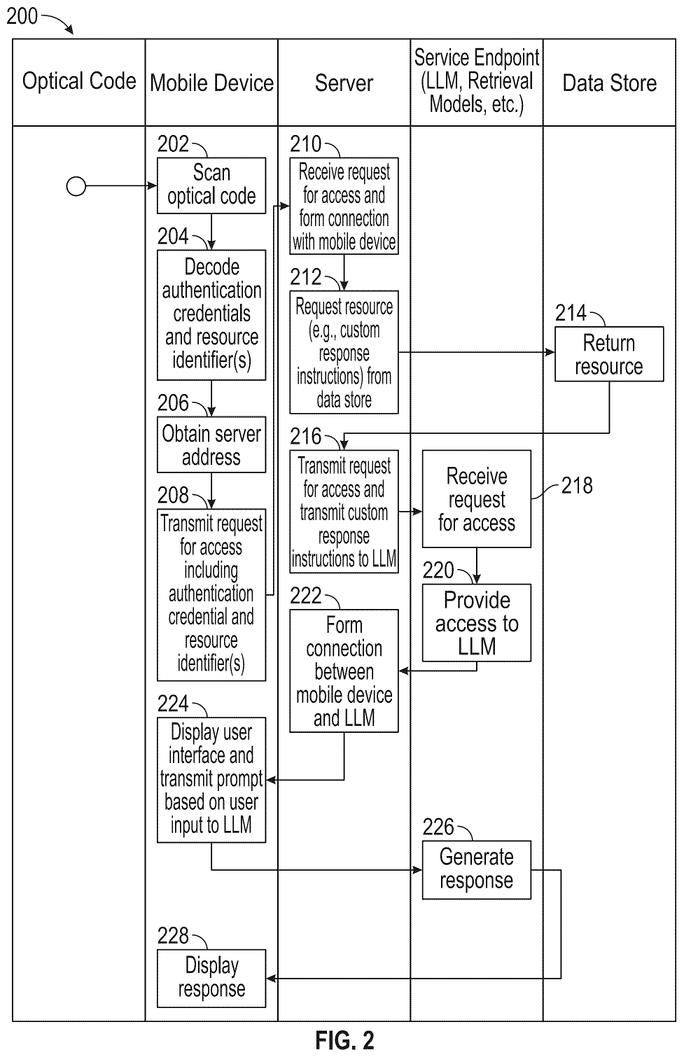

FIG. 2 illustrates an exemplary method 200 for causing display of an interface at a display of an electronic device configured to enable a user to interact with a pre-trained machine learning model that can generate responses associated with an asset. Method 200 is performed, for example, using one or more electronic devices implementing a software platform. In some examples, method 200 is performed using one or more electronic devices. In some embodiments, the one or more electronic devices may be mobile devices. In some embodiments, method 200 is performed using a client-server system, and the blocks of method 200 are divided up in any manner between the server and one or more client devices. Thus, while portions of method 200 are described herein as being performed by particular devices, it will be appreciated that method 200 is not so limited. In FIG. 2, the various blocks depict steps in method 200. Some blocks, or steps, may be optionally combined, reordered, or omitted in accordance with various examples. In some examples, additional steps may be performed in combination with the method 200. In some embodiments, method 200 may be performed at a system such as system 100 discussed above with reference to FIG. 1. Accordingly, the operations as illustrated (and described in greater detail below) are exemplary by nature and, as such, should not be viewed as limiting.

Referring to FIG. 2, at block 202, a mobile device 104 can scan an optical code, e.g. optical code 102, using an optical sensor of the mobile device. The optical code 102 may be associated with an asset, such as a shipping facility, a location within a shipping facility, a system of a shipping facility, shipping facility equipment, or a shipped item (such as a package, etc.). The association between the optical code and the asset may or may not be physical. In other words, the optical code 102 may be physically located on or near the asset, or it may be remotely associated with the asset (e.g., located at a different location from the asset) instead. For instance, in some embodiments, a digital representation of the optical code 102 may be displayed at a display of an electronic device that may or may not be affixed to the asset. In some embodiments, a physical representation (e.g., printout) of the optical code 102 may be taped, glued, fastened, or otherwise affixed to the asset. In some embodiments, the optical code 102 may be located proximally to the asset but not physically located on the asset. For instance, the optical code 102 may be affixed to a wall adjacent to a loading dock door (e.g., where the asset is the loading dock door), or it may be affixed adjacent to a control panel (e.g., where the asset is a security system, climate control system, and so on). In some embodiments, the location of the optical code 102 may be entirely unrelated to the location of the asset. For instance, the optical code 102 may be provided in a user manual, email, or other physical or electronic document associated with the asset, such that the optical code 102 can be detected by mobile device 104 at any distance away from the asset. The optical code 102 may encode authentication information, resource identification information (e.g., a URL, or other resource identifier information), or other information to be decoded by the mobile device, as described further below.

At block 204, the mobile device 104 may decode the optical code 102 to extract information. The decoded information may include an authentication portion and a lookup portion. The authentication portion encoded within optical code 102 may include authentication information (e.g., one or more authentication codes or credentials). The authentication portion may be configured to authorize a communication link between the mobile device 104 and server 106 and/or a service endpoint 110, e.g., an LLM. The lookup portion encoded within optical code 102 may include resource identifier information that may point to various servers and/or data stores 106, 108, that may retrieve and/or store custom response instructions for prompting the LLM. The lookup portion may further contain information that allows the mobile device 104 to locate and access one or more local or remote network resources, for instance by opening an internet-accessible webpage in a web browser that communicates with a server when the optical code is scanned by the mobile device. In some embodiments, the lookup portion may include one or more Uniform Resource Identifiers (URI), Universal Resource Names (URN), Universal Resource Locators (URL), and/or other identifier information.

At block 206, the mobile device 104 may obtain a server address from within the decoded information. Then, at block 208, the mobile device may transmit a request for access to the server identified by the server address obtained from the decoded information. The request for access may include decoded information from the authentication portion (e.g., one or more authentication codes) and/or decoded information from the lookup portion (e.g. resource identifier information) obtained from scanning the optical code. The request for access may optionally include identifying information for the mobile device, a geographic location from which the mobile device is transmitting the request, or identifying information of a user profile that is associated with the device or is signed into the user interface. In this manner, the request for access may be permitted or denied based on the identity of the user and/or the mobile device that scanned the optical code. Then, at block 210, the server 106 may receive the request for access from the mobile device 104, and the server may form a connection with the mobile device.

At block 212, once the connection between the server 106 and mobile device 210 has been established, server 106 may request a resource from data store 108. The resource requested may be the custom response instructions for prompting the LLM. The server may determine which custom response instructions to request based on the resource identifier information transmitted in the request for access at block 208, which was originally obtained from decoding the optical code 102. In some examples, the resource requested may be dependent on the identity of the user and/or mobile device that scanned the optical code, such that the LLM may be provided with different custom response instructions depending on the identity and/or credentials of the user or the device that scans the optical code. At block 214, a data store 108 may then return the resource, or custom response instructions, requested by server 106.

To summarize, the lookup portion of the decoded information may be unique to the optical code that is scanned, and the optical code may be associated with a particular asset. The lookup portion can contain resource identifier information, such as information pointing to the location and content of the custom response instructions that are needed to prompt the LLM to respond as the asset. This resource identifier information can be included in the request for access from the mobile device 104 to the server 106 at block 208 and can be transmitted from the mobile device to the server when the connection is formed between the mobile device and server at block 210. The resource identifier information can then be used by server 106 to locate and transmit a request for a resource from a particular data store 108 that contains the custom response instructions it needs at block 212. The data store 108 can return the requested custom response instructions to the server at block 214.

At block 216, once server 106 receives the response instructions from data store 108, the server may then transmit a request to access the service endpoint 110, which may be a large language model (LLM), a multimodal machine learning model, or any other type of artificial intelligence model. Although service endpoint 110 may be specifically described as being an “LLM” in some embodiments, it is to be understood that service endpoint 110 is not so limited. At block 216, server 106 may also transmit the custom response instructions for prompting the LLM that were sent from the data store 108 to the server 106 at block 214. The LLM may be configured, e.g. pre-trained, prompted, and/or otherwise customized, to imitate an asset. For example, the LLM may be prompted to replicate a desired asset, provide information about an asset, or respond from the point of view of a desired asset when prompted by the custom response instructions that are transmitted to the LLM by the server at block 216. In some embodiments, the custom response instructions may be stored in storage (e.g., memory) in the electronic device instead of, or in addition to, a server that can cause the electronic device itself to send the custom response instructions to the LLM, along with the user's input. In some embodiments, the LLM may be configured to imitate more than one asset, and even extremely large numbers of assets. For example, an LLM can be configured to imitate millions, tens of millions, hundreds of millions, or billions of different assets.

The asset that the LLM is configured to imitate, or respond as, may be chosen to fit the particular needs of a person or business. For example, a business may have a particular need to obtain up-to-date logistical information about a loading dock. Thus, the desired asset the LLM can be configured to imitate can be a loading dock, and the custom response instructions can prompt the LLM to respond in a manner that serves the logistical need. For example, the custom response instructions may be along the lines of “You are a loading dock expecting a shipment of [product P] from [company C] at [time T2], which departed from [location L] at [time T1]. Respond to all subsequent queries and prompts during this session accordingly.” In some embodiments, the custom response instructions may include a natural language prompt for prompting the LLM to imitate the asset. Furthermore, the custom response instructions may determine the functions that the LLM may be capable of performing in response to a user input, such as scheduling a shipment, rebooking a pick-up, providing proof-of-delivery, and so on.

Next, at block 218, the LLM may receive the server's request for access, and the LLM may grant the server access at block 220. From there, the server may be able to form a connection between the mobile device and the LLM at block 222 that will allow a user to interact with the LLM directly at block 224. For example, at block 224, a user may interact with the LLM through a user interface that is displayed on their mobile device. This user interface may allow the user to enter an input that will prompt a response from the LLM. In some embodiments, the input from the user may comprise natural language. In some embodiments, the input may comprise text that is typed into the user interface by the user. In some embodiments, the input may comprise speech from the user that may be converted into text by the mobile device and/or server. In some embodiments, the input from the user may comprise a request for information or data associated with the asset.

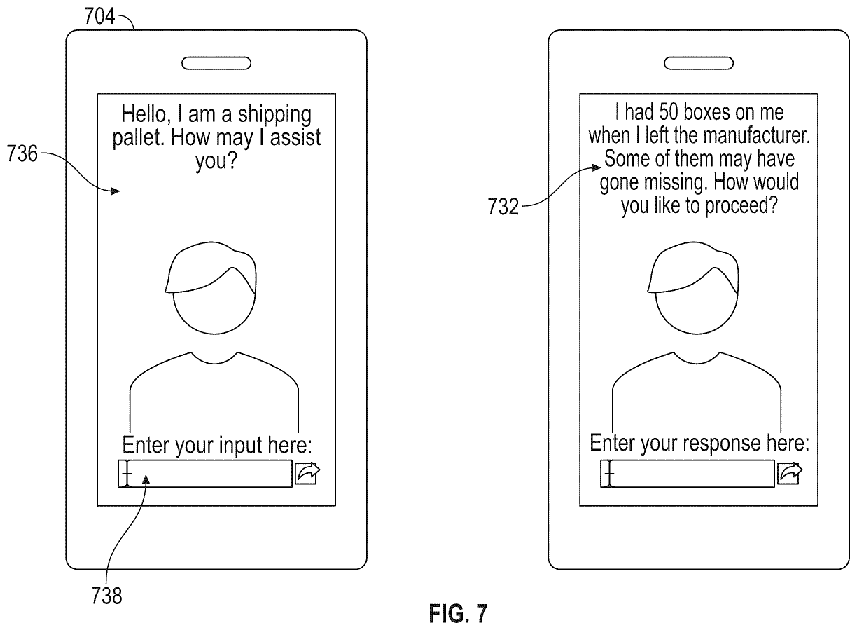

FIG. 7 illustrates an exemplary user interface 736 displayed on a mobile device 704, according to some embodiments. The user interface 736 may allow a user to interact with an LLM by displaying a chat box 724 or any other suitable dialogue box prompting the user to enter an input. The user interface 736 may include a visual representation of a “virtual agent” to improve a user's experience. The user interface may display an output 732 that includes the LLM's response to the user's query. The LLM may respond in a user-friendly, casual, or conversational manner to facilitate ease of the user interacting with the LLM, subject to the manner in which the LLM is instructed to respond to the user based on the custom response instructions.

In this example, the LLM may be represented by a virtual agent that can imitate an asset, which in this case is a shipping pallet. With the user interface 736, the user may enter an input asking the LLM about a discrepancy between the number of boxes actually received on the shipping pallet versus the number of boxes that were shipped out. The virtual agent may respond to the user's query and display this response as an output 732. The virtual agent may offer additional assistance and/or allow the user to end the interaction, subject to the custom response instructions.

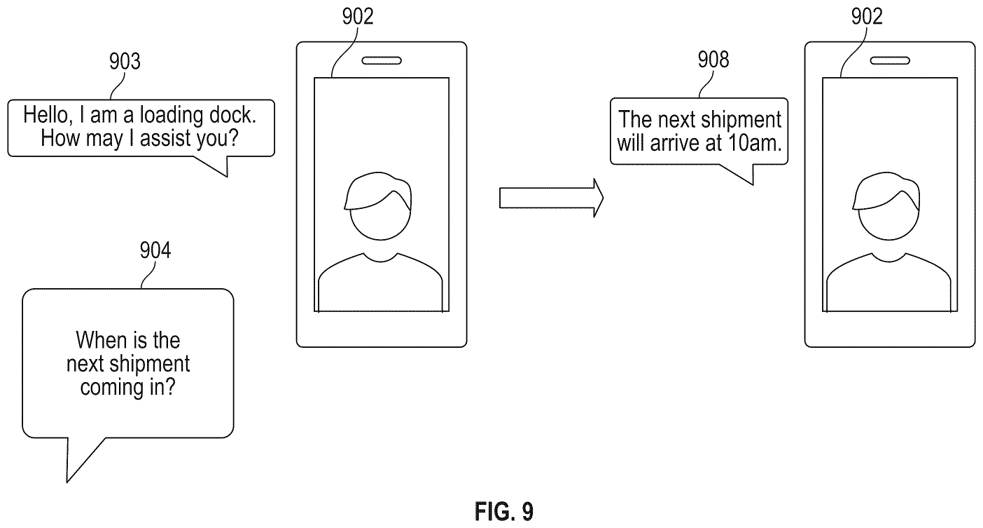

In some examples, as shown in FIG. 9, the user interface 902 may enable the user to provide a user input 904 in the form of speech and/or other audio into a microphone that is built into or is in communication with the mobile device. In this example, the virtual agent in the user interface 902 delivers an audio message 903 inviting the user to provide their input, such that the user interface 902 enables audio-based bi-directional communication. The user may additionally or alternatively be invited to provide their audio input via a visual message displayed on the user interface, as shown at user interface 702 in FIG. 7. Still referring to FIG. 9, the virtual agent in the user interface 902 may provide an audio output 908 responding to the user input 904 through the built-in speakers of the mobile device or a different output device physically or communicatively connected to the mobile device (e.g., a Bluetooth or wired headset or pair of headphones).

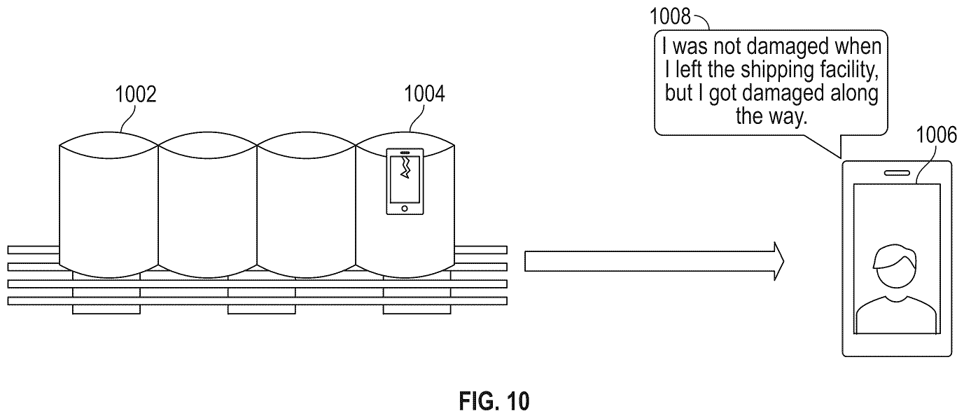

In some examples, as shown in FIG. 10, the user interface 1006 may enable the user to provide a user input 1004 in the form of a visual input (e.g., image or video), which may be captured using a camera built into and/or physically or communicatively coupled to the mobile device. The user may be provided with an output that includes a machine learning model's analysis of the captured image. In this example, the user is taking an image of suspected damage on an asset, shipment 1002. The image in the user input 1004 may be analyzed by a multimodal machine learning model to assess the damage by comparing the image with pre-existing information associated with the asset that is stored in data store 108. Based on the machine learning model's analysis, the virtual agent of the user interface 1006 may provide an output 1008 indicating the source or timing of the damage. In some examples, output 1008 may be an audio output, as shown in FIG. 10. In other examples, output 1008 may be visually displayed on the user interface 1006. Output 1008 may include text and/or one or more annotations over the captured image indicating the results of the machine learning model's analysis, for example, a machine learning model's analysis of the extent of photographed damage on an asset.

Referring back to FIG. 2, the user input from block 224 may then be transmitted to the LLM. Based on the user input, the LLM may generate a response to the user input at block 226. As explained earlier, the LLM's response to the user may be based on custom response instructions sent to the LLM from the server in block 216 which were chosen based on the particular asset that will be imitated by the LLM. For example, if the asset is a loading dock, and the user input is the user asking the LLM what time the next delivery will be arriving, the custom response instructions provided to the LLM will prompt the LLM to respond as if the loading dock was telling the user what time the next delivery will arrive. Finally, at block 228, the LLM's response may be displayed at the user interface on the mobile device and blocks 224-228 may be repeated until the interaction is terminated by the user. If the custom response instructions in the data store are insufficient to allow the LLM to fully respond to the user input, one or more error messages may be displayed on the user interface. These error messages may advise the user of alternative methods of getting help with their request, or they may simply tell the user that the LLM is unable to assist, or they may prompt the user to enter their input again.

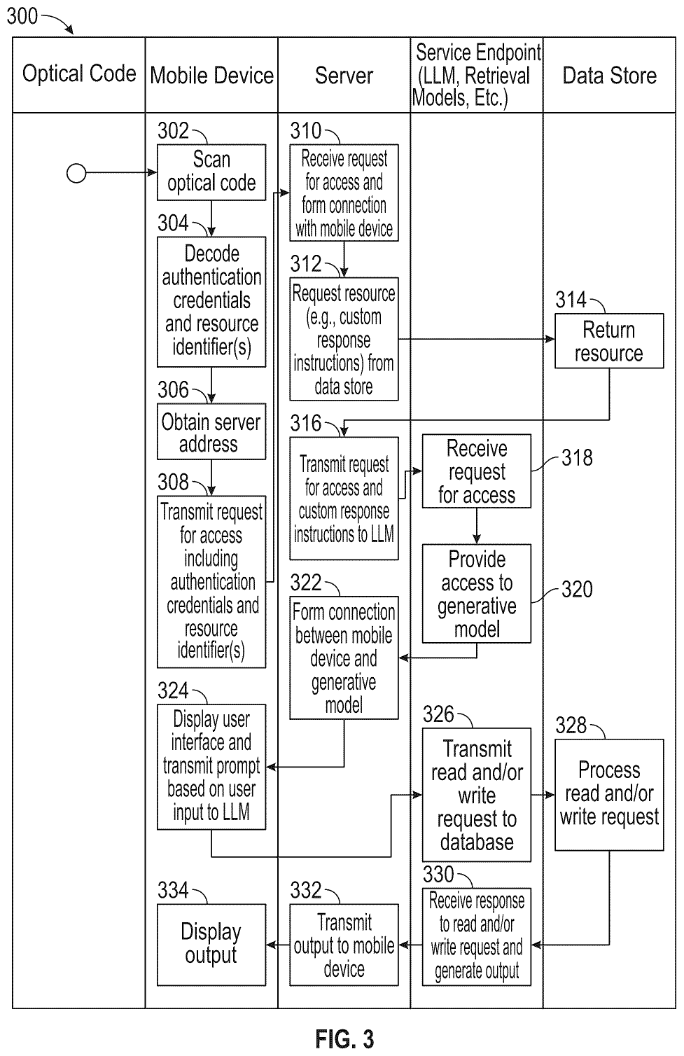

Referring to FIG. 3, this figure illustrates another exemplary method 300. In method 300, blocks 302-322 can be the same as blocks 202-222 from method 200 in FIG. 2 previously described. However, at blocks 324-326, data associated with the user input in the user interface can be transmitted from the LLM to data store 108 in the form of a read and/or write request. For example, the LLM may need to access data from data store 108 in order to respond to the user input, such as when a user asks the LLM for readings from a device or sensor that are stored in the data store, or if the user input requires the LLM to access the custom response instructions. In this example, the LLM may transmit a read request to data store 108 based on the user input at block 326. Additionally, the LLM may transmit a write request to data store 108 to write data associated with a user input into the data store at block 326. This allows the data associated with the user input to be stored in the data store for future reference so that the custom response instructions in the data store can be continuously refined. For instance, if the asset was a shipping pallet, and the user wanted to update information stored in the data store regarding the shipping pallet, for example to indicate that the pallet had been sent to the wrong location, the user input may say “Update the custom response instructions to reflect that you are a shipping pallet that got lost at Location Y. Respond to all subsequent queries and prompts accordingly.” Based on this user input, the LLM may transmit a write request to data store 108 to write the new location information (e.g., to reflect the pallet being lost at location Y), new time information, and/or new custom response instructions into the data store 108. In some embodiments, the read/write location in the data store that is specified in the read/write request may be the same location in the data store where the custom response instructions were retrieved from. In some embodiments, the read/write location in the data store may be a different location from where the custom response instructions were retrieved from.

At block 328, data store 108 may process the read and/or write request from the LLM and respond to the LLM's request. This response may include custom response instructions and/or data from the data store that the LLM can use to generate an output. In examples where a write request is transmitted to the data store 108, the transmission step at block 326 and the processing step at block 328 may occur in parallel. The LLM may generate an output at block 330 that is transmitted to the mobile device at block 332 and is then displayed on the user interface on the mobile device at block 334.

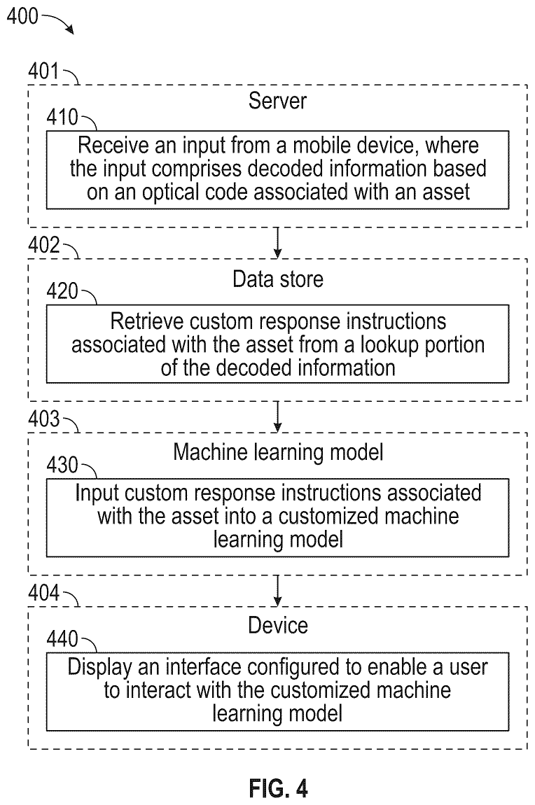

FIGS. 4-6 represent the same or similar methods as FIGS. 2 and 3, demonstrating fewer, broader steps. However, it can be appreciated that the steps shown in FIGS. 4-6 may include or overlap with steps listed in the blocks shown in FIGS. 2 and/or 3. As such, in FIGS. 4-6, one or more intermediate steps may take place in between or within the broader steps shown in the flow charts. Accordingly, the steps in FIGS. 2-3 may supplement the steps in FIGS. 4-6, and vice versa.

Referring to FIG. 4, methods 200 and/or 300 can be distilled down into the 4 steps shown in method 400. Server 401 can receive a transmission from a mobile device 404, where the transmission comprises decoded information based on an optical code associated with an asset at step 410. At step 420, data store 402 may retrieve custom response instructions associated with the asset from a lookup portion of the decoded information. At step 430, the custom response instructions associated with the asset can be transmitted by the server to a machine learning model 403. Then, at step 440, the server may transmit instructions to the mobile device to display an interface at a display of the mobile device, the interface configured to enable a user of the mobile device to interact with the machine learning model subject to the custom response instructions device 404 may display an interface configured to enable a user to interact with the machine learning model 403.

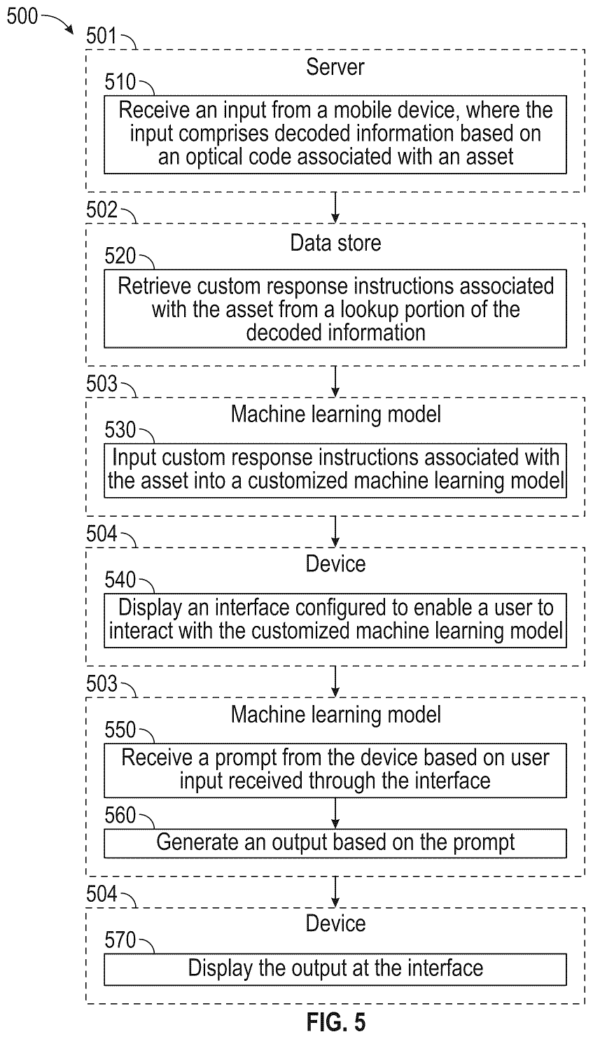

Referring to FIG. 5, method 500 may include steps 510, 520, 530, and/or 540, which may be the same as steps 410, 420, 430, and/or 440 in method 400. Additionally, method 500 may include additional steps relating to the machine learning model's response to input that is provided by a user. For example, at step 550, machine learning model 503 may receive a prompt from the device based on user input received through the user interface from step 540. Data store 502 may receive and store data associated with the prompt in embodiments where the machine learning model transmits a write request into the data store, such as in blocks 326-330 in FIG. 3. At step 560, machine learning model 503 may generate an output based on the prompt, and at step 570, instructions may be transmitted to the device 504 to display this output at the user interface.

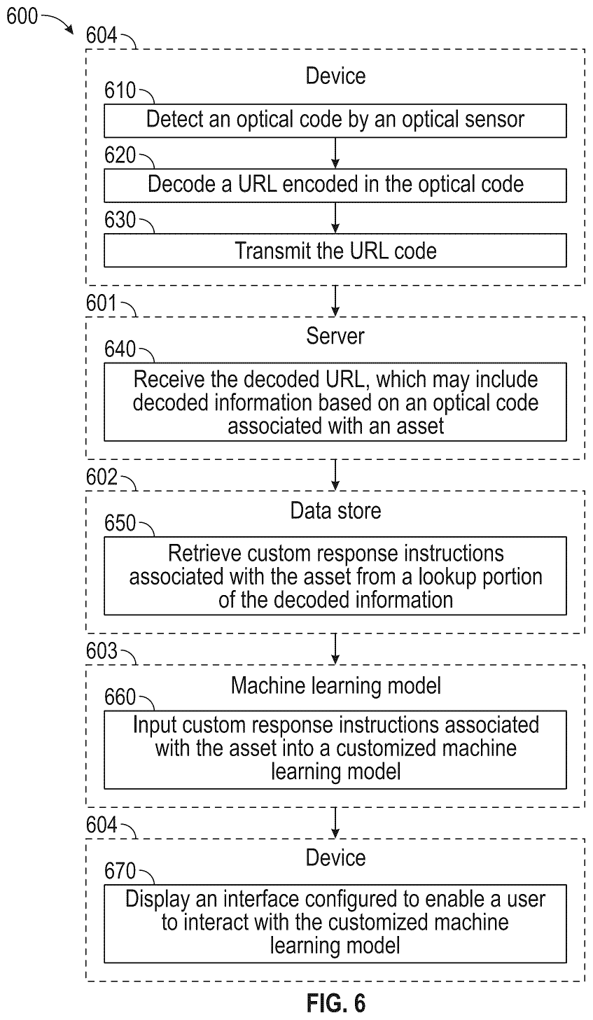

Referring to FIG. 6, method 600 may include steps 650, 660, and/or 670, which may be the same as steps 420, 520; 430, 530; and/or 440, 540 from method 400 and/or 500. However, method 600 includes several additional steps prior to step 650, the retrieval of custom response instructions associated with an asset. For example, at step 610, device 604 may detect an optical code by an optical sensor, and then at step 620, device 604 may decode a URL encoded in the optical code that is associated with an asset. Device 604 may then transmit the URL code to server 601 at step 630, which can point the server 601 to the data store 602 that contains the custom response instructions for prompting machine learning model 604. In other words, method 600 depicts an exemplary embodiment where the resource identifier information for the custom response instructions comes from a URL that is associated with the asset. As explained in more detail above, step 620 may involve other resource identifier information encoded in the optical code, such as a Uniform Resource Identifier (URI) or Universal Resource Name (URN), instead of or in addition to a URL.

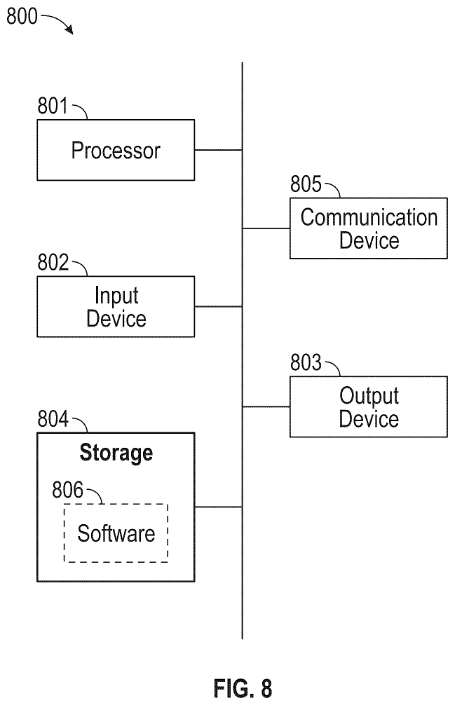

FIG. 8 depicts parts of a computer, in accordance with various embodiments. As will be appreciated, system 100, described with respect to FIG. 1, can include one or more of the components as will be described with respect to computer 800. Computer 800 can be a component of a system that can be used for causing display of an interface at a display of a mobile device configured to enable a user to interact with a pre-trained machine learning model, where the machine learning model is configured to generate responses associated with an asset. Additionally, or alternatively, one or more elements of the systems described herein may be in remote communication with one or more computers such as computer 800.

Computer 800 can be a host computer connected to a network. Computer 800 can be a client computer or a server. As shown in FIG. 8, computer 800 can be any suitable type of microprocessor-based device, such as a personal computer, workstation, server, videogame console, or handheld computing device, such as a phone or tablet. The computer can include, for example, one or more of processor 801, computer input device 802, output device 803, storage 804, and communication device 805. Computer input device 802 can generally correspond to those described above and can either be connectable or integrated with the computer.

Computer input device 802 can be any suitable device that provides input, such as a touch screen or monitor, keyboard, mouse, or voice-recognition device. Output device 803 can be any suitable device that provides output, such as a touch screen, monitor, printer, disk drive, or speaker.

Storage 804 can be any suitable device that provides storage, such as an electrical, magnetic, or optical memory, including a RAM, cache, hard drive, CD-ROM drive, tape drive, removable storage disk, or other non-transitory computer readable medium. Storage 804 can include one storage device or more than one storage device. As used herein, the terms storage, memory, and/or storage medium/media may refer to singular and/or plural devices which may store data and/or code/instructions individually, redundantly, and/or in cooperation with one another, for example in a local and/or cloud storage environment. Communication device 805 can include any suitable device capable of transmitting and receiving signals over a network, such as a network interface chip or card. The components of the computer can be connected in any suitable manner, such as via a physical bus or wirelessly. Storage 804 can be a non-transitory computer-readable storage medium comprising one or more programs, which, when executed by one or more processors, such as processor 801, cause the one or more processors to execute methods described herein.

Software 806, which can be stored in storage 804 and executed by processor 801, can include, for example, the programming that embodies the functionality of the present disclosure (e.g., as embodied in the systems, computers, servers, and/or devices as described above). In some embodiments, software 806 can be implemented and executed on a combination of servers such as application servers and database servers.

Software 806, or part thereof, can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 804, that can contain or store programming for use by, or in connection with, an instruction execution system, apparatus, or device.

Software 806 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 800 can implement any operating system suitable for operating the network. Software 806 can be written in any suitable programming language, such as C, C++, Java, or Python. In various embodiments, application software embodying the functionality of the present disclosure can be deployed in different configurations, such as in a client/server arrangement or through a web browser as a Web-based application or Web service, for example.

1. A method for automatically configuring a machine learning model and providing access to the configured machine learning model, the method performed by a system comprising one or more processors, the method comprising:
receiving a transmission from a mobile device comprising decoded information based on an optical code associated with an asset, wherein the decoded information comprises a lookup portion;
retrieving custom response instructions associated with the asset from a storage location determined based on the lookup portion of the decoded information;
transmitting the custom response instructions to a machine learning model; and
transmitting instructions to the mobile device to display an interface at a display of the mobile device, the interface configured to enable a user of the mobile device to interact with the machine learning model subject to the custom response instructions.

2. The method of claim 1, wherein the storage location is a data store associated with the asset.

3. The method of claim 1, wherein the custom response instructions prompt the machine learning model to generate a response based on data in the storage location associated with the asset.

4. The method of claim 1, wherein the custom response instructions prompt the machine learning model to imitate the asset.

5. The method of claim 1, further comprising: prior to transmitting instructions to the mobile device to display an interface at a display of the mobile device, establishing, based on an authentication portion of the decoded information, a connection between the mobile device and a machine learning model.

6. The method of claim 5, wherein the authentication portion of the decoded information comprises one or more authentication codes for authenticating a connection with at least one of the system and the machine learning model.

7. The method of claim 1, wherein the asset is any of a shipping facility, a location within a shipping facility, a system of a shipping facility, shipping facility equipment, or a shipped item.

8. The method of claim 1, further comprising:
receiving, by the machine learning model, a prompt from the mobile device based on a user input;
generating, by the machine learning model, an output based on the prompt; and
transmitting instructions to the mobile device to provide the output at the mobile device.

9. The method of claim 7, wherein the user input comprises a natural language input.

10. The method of claim 7, wherein the user input comprises an audio input.

11. The method of claim 7, wherein the user input comprises a visual input.

12. The method of claim 7, wherein the method further comprises: transmitting a write request for information included in the user input to the storage location associated with the asset.

13. The method of claim 7, wherein the method further comprises transmitting a read request comprising a request for information to the storage location associated with the asset.

14. The method of claim 13, wherein the method further comprises: prior to generating the output based on the prompt, retrieving data from the storage location based on the read request, and wherein the output is based on the data retrieved from the storage location.

15. The method of claim 14, wherein the output comprises the data retrieved from the storage location.

16. The method of claim 1, wherein prior to receiving a transmission from a mobile device comprising decoded information based on an optical code associated with an asset, the method further comprises:
at the mobile device:
detecting the optical code by an optical sensor of the mobile device;
decoding a URL encoded in the optical code; and
transmitting the URL to the system.

17. The method of claim 1, wherein the optical code is located physically on the asset.

18. The method of claim 1, wherein the optical code is at a different location from the asset.

19. The method of claim 1, wherein the decoded information comprises a URL associated with the machine learning model.

20. The method of claim 1, wherein the decoded information comprises a natural language prompt for prompting the machine learning model to imitate the asset.

21. A system for automatically configuring a machine learning model and providing access to the configured machine learning model, the system comprising:
one or more processors; and
memory storing computer program code executable by the one or more processors to cause the system to:
receive a transmission from a mobile device comprising decoded information based on an optical code associated with an asset, wherein the decoded information comprises a lookup portion;
retrieve custom response instructions associated with the asset from a storage location determined based on the lookup portion of the decoded information;
transmit the custom response instructions to a machine learning model; and
transmit instructions to the mobile device to display an interface at a display of the mobile device, the interface configured to enable a user of the mobile device to interact with the machine learning model subject to the custom response instructions.

22. A non-transitory computer readable storage medium storing one or more programs, the one or more programs comprising instructions, which, when executed by one or more processors of a system, cause the system to:
receive a transmission from a mobile device comprising decoded information based on an optical code associated with an asset, wherein the decoded information comprises a lookup portion;
retrieve custom response instructions associated with the asset from a storage location determined based on the lookup portion of the decoded information;
transmit the custom response instructions to a machine learning model; and
transmit instructions to the mobile device to display an interface at a display of the mobile device, the interface configured to enable a user of the mobile device to interact with the machine learning model subject to the custom response instructions.
